(19) United States
(12) Patent Application Publication
(10) Pub. No.: US 2014/0059983 A1
(43) Pub. Date: Mar. 6, 2014

(54) DUST SEPARATOR

(71) Applicant: Yu-Pei Ho, Taichung City (TW)

(72) Inventor: Yu-Pei Ho, Taichung City (TW)

(73) Assignee: Everinn International Co., Ltd., Taichung City (TW)

(21) Appl. No.: 13/605,611

(22) Filed: Sep. 6, 2012

(51) Int. Cl. B01D 45/16

(52) U.S. Cl. 55/343

(57) ABSTRACT

A dust separator includes: a partitioner mounted in a shell and including an upper cup part; and a multi-cone unit supported on the upper cup part and including a plurality of cones, each of which has an upper end portion formed with a tangent channel-forming notch and having a circumferentially-extending segment and a tangentially-extending segment. The circumferentially-extending segment has an end face disposed at one side of the tangent channel-forming notch. The tangentially-extending segment has an inner face that confines the other side of the tangent channel-forming notch. The tangentially-extending segment of each of the cones sidewisely joins an end section of the circumferentially-extending segment of an adjacent one of the cones.

### BACKGROUND OF THE INVENTION

1. Field of the Invention

This invention relates to a dust separator, more particularly to a dust separator including a plurality of cones sidewisely interconnected to one another and formed with tangentially-extending tangent channel-forming notches.

2. Description of the Related Art

Referring to FIG. 1, U.S. Pat. No. 6,840,972 discloses a conventional dust separator including primary and secondary cyclone dust collectors 1, 2, a suction conduit 4 connected to the secondary cyclone dust collector 2, and a fan 3 connected to the suction conduit 4. Since the secondary cyclone dust collector 2 works in single cyclone, the dust separating efficiency thereof is relatively low.

Although dust separators with multiple cyclones have been developed for increasing dust separating efficiency, additional piping is required to connect the cyclones, which increases the manufacturing costs.

### SUMMARY OF THE INVENTION

Therefore, an object of the present invention is to provide a dust separator that can overcome the aforesaid drawbacks associated with the prior art.

According to this invention, there is provided a dust separator that comprises: a shell having a cylindrical tank body and an air inlet channel, the air inlet channel extending in a tangential direction relative to the tank body; a partitioner mounted in the shell and cooperating with the shell to define a first cyclone chamber therebetween, the first cyclone chamber being in fluid communication with the air inlet channel, the partitioner having an upper cup part and a lower part that is disposed below the upper cup part, the upper cup part defining a top opening and a cup inner space and being formed with at least one cup-wall through-hole that is in fluid communication with the first cyclone chamber and the cup inner space, the lower part defining a dust collecting space that is isolated from the first cyclone chamber and the cup inner space; and a multi-cone unit supported on the upper cup part to cover the top opening of the upper cup part and including a plurality of cones that extend through the cup inner space into the dust collecting space. Each of the cones has an upper end portion that is formed with a tangent channel-forming notch having two opposite sides. The upper end portion has a circumferentially-extending segment and a tangentially-extending segment extending tangentially from the circumferentially-extending segment. The circumferentially-extending segment has an end section that defines an end face. The end face of the end section is disposed at one of the sides of the tangent channel-forming notch. The tangentially-extending segment has an inner face that confines the other of the sides of the tangent channel-forming notch. The tangentially-extending segment of each of the cones sidewisely joins the end section of the circumferentially-extending segment of an adjacent one of the cones. Each of the cones defines a lower opening in fluid communication with the dust collecting space, and a second cyclone chamber in fluid communication with the lower opening and the tangent channel-forming notch. An air flow introduced into the first cyclone chamber via the air inlet channel is caused to flow in a helical pattern to thereby result in a first separation of air from dust carried by the air flow. The air flow introduced from the first cyclone chamber into the second cyclone chamber via the tangent channel-forming notches of the cones is caused to flow in a helical pattern to result in a second separation of air from dust carried by the air flow.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary schematic partly sectional view of a conventional dust separator illustrated in U.S. Pat. No. 6,840,972;

FIG. 2 is an exploded perspective view of the first preferred embodiment of a dust separator according to the present invention;

FIG. 3 is an assembled perspective view of the first preferred embodiment;

FIG. 4 is a sectional view of the first preferred embodiment;

FIG. 5 is a top view of a multi-cone unit of the first preferred embodiment;

FIG. 6 is a perspective view of the multi-cone unit of the first preferred embodiment;

FIG. 7 is a sectional view illustrating an operating state of the first preferred embodiment, in which vortexes of an air flow are created in a first cyclone chamber and second cyclone chambers of the first preferred embodiment;

FIG. 8 is a top view illustrating a flow pattern of the air flow passing through a central space and tangent channel-forming notches of cones of the multi-cone unit of the first preferred embodiment;

FIG. 9 is a schematic view of the second preferred embodiment of the dust separator according to the present invention, in which the second preferred embodiment is operated in a suctioning mode;

FIG. 10 is a schematic view of the second preferred embodiment operated in a blowing mode;

FIG. 11 is a schematic view of the first preferred embodiment of a dust separating system according to the present invention;

FIG. 12 is a schematic view of the second preferred embodiment of the dust separating system according to the present invention;

FIG. 13 is a schematic diagram of the third preferred embodiment of the dust separating system according to the present invention;

FIG. 14 is a schematic diagram of the third preferred embodiment of the dust separating system disposed at an operating condition;

FIG. 15 is a schematic diagram of the third preferred embodiment of the dust separating system disposed at another operating condition;

FIG. 16 is a schematic view of the fourth preferred embodiment of the dust separating system according to the present invention; and

FIG. 17 is a schematic view of the fifth preferred embodiment of the dust separating system according to the present invention.

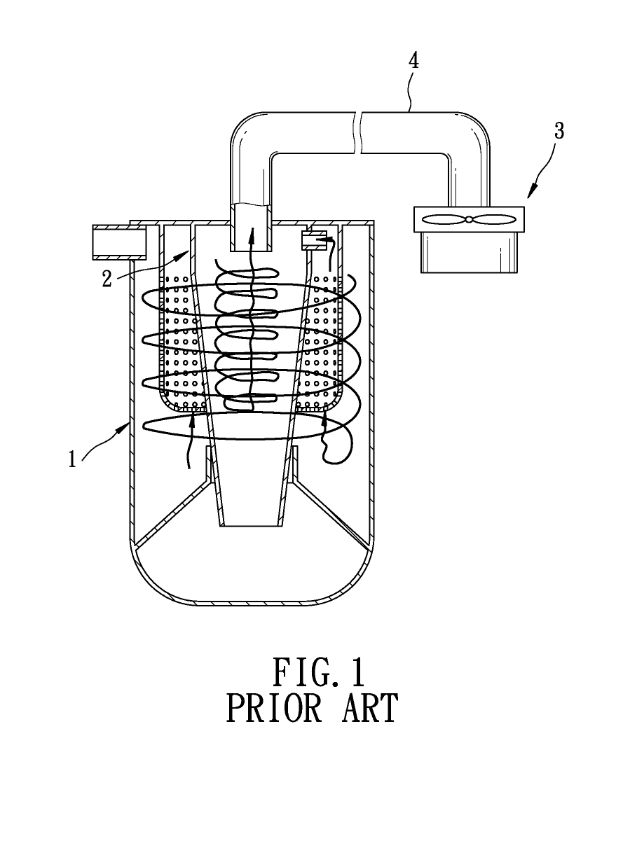

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

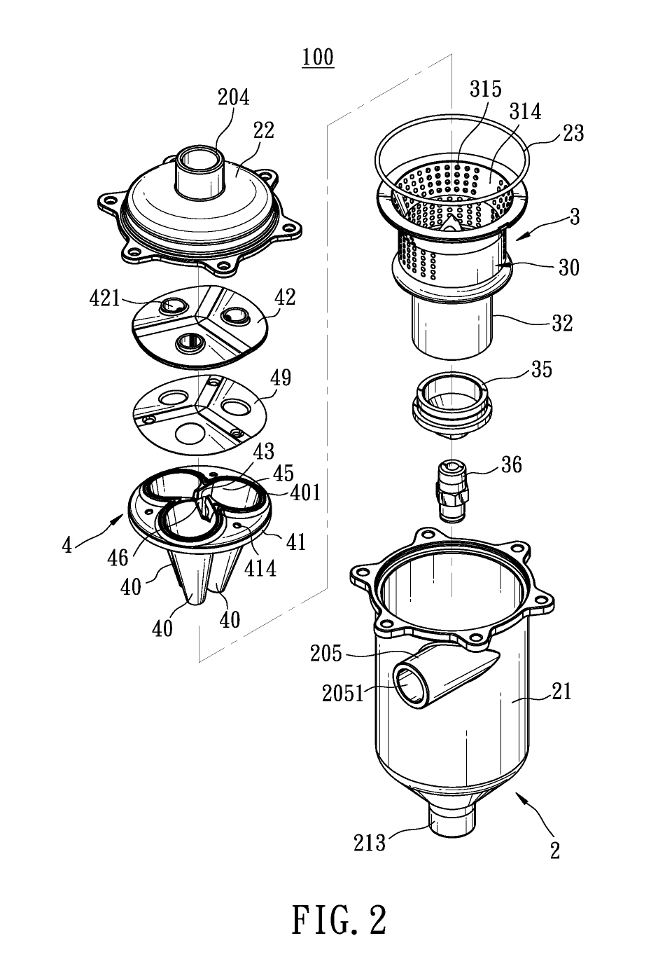

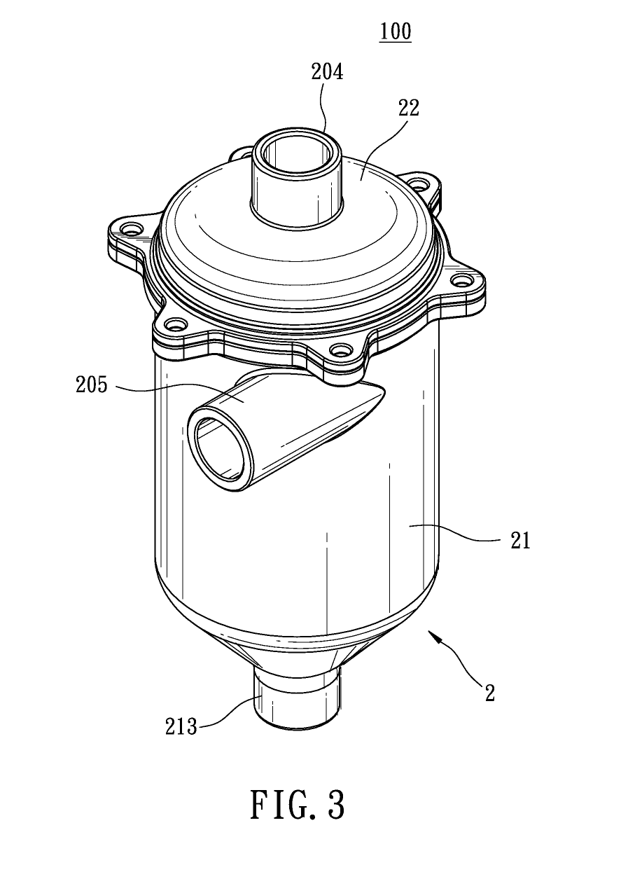

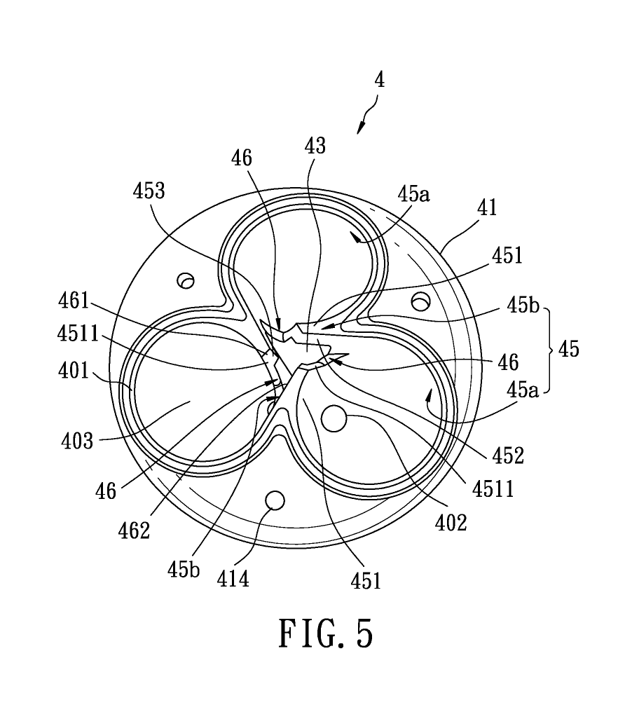

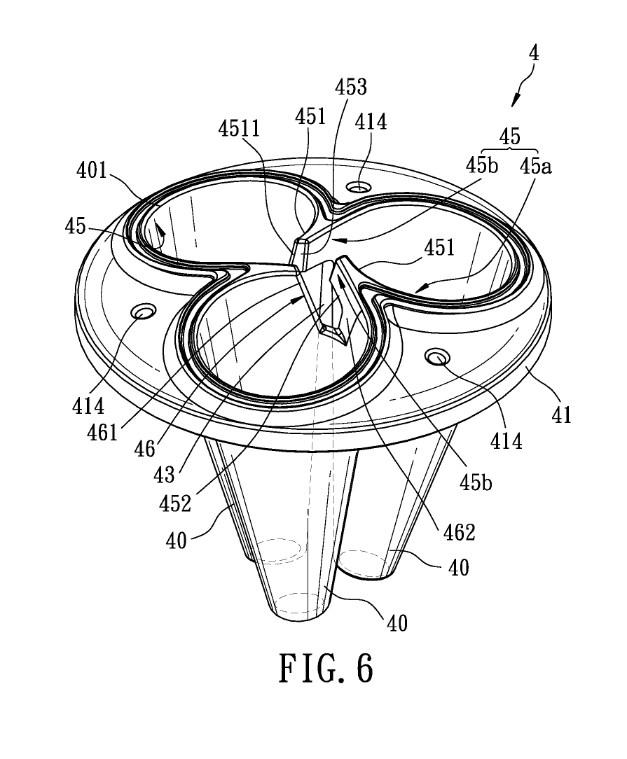

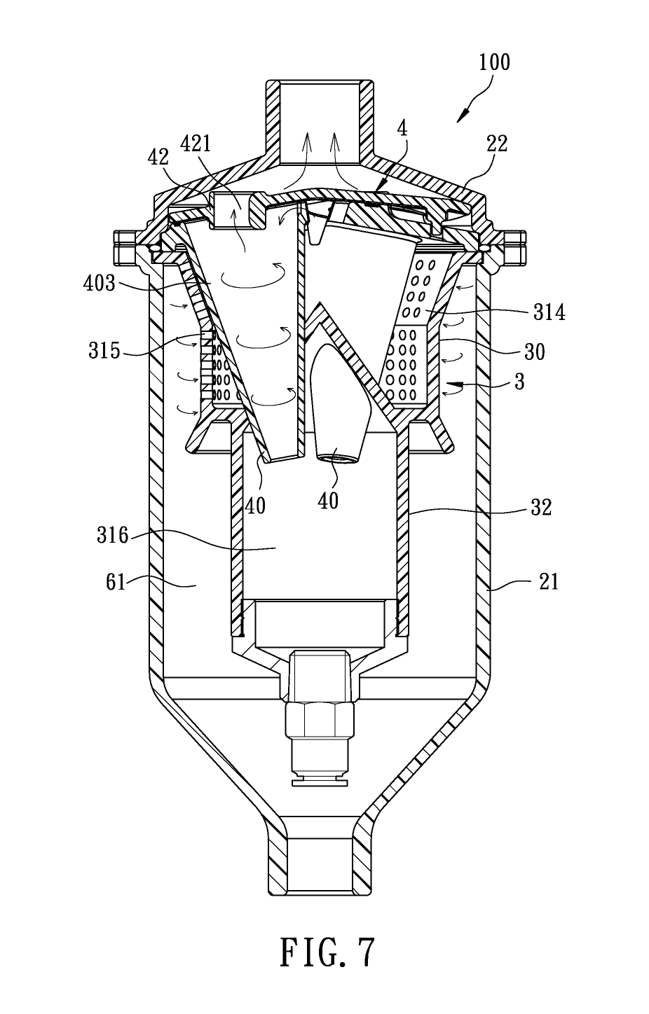

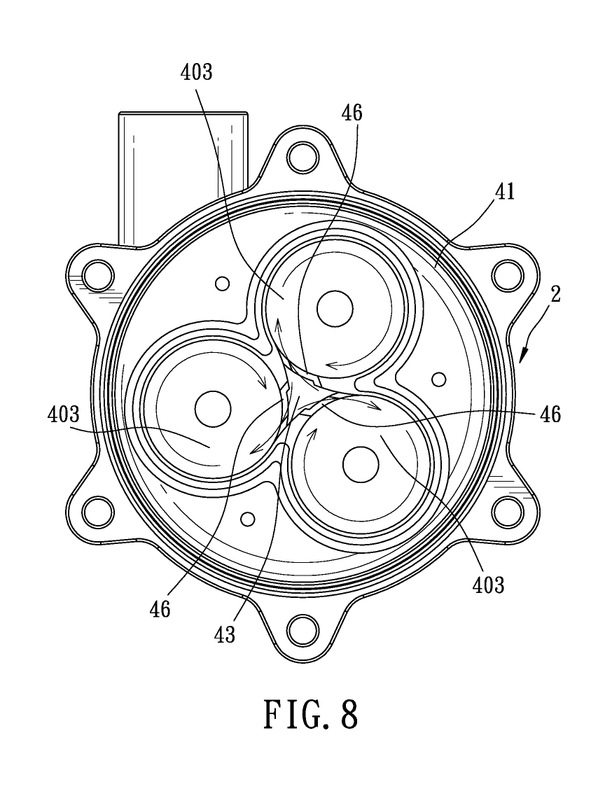

FIGS. 2 to 8 illustrate the first preferred embodiment of a dust separator 100 according to the present invention. The dust separator 100 includes a shell 2, a partitioner 3, and a multi-cone unit 4.

The shell 2 has a cylindrical tank body 21 and a top cover 22 disposed on a top open end of the tank body 21. A sealing ring 23 is disposed between and is in sealing contact with the top cover 22 and the top open end of the tank body 21. The tank body 21 has a surrounding wall 212 and a bottom dust-discharging tube 213 extending downwardly from a funnel-shaped lower end portion of the surrounding wall 212. The surrounding wall 212 has a top end portion that is formed with a top shoulder 2123. The shell 2 further has an inlet tube 205 extending tangentially from the top end portion of the surrounding wall 212 and defining an air inlet channel 2051 that extends in a tangential direction relative to the tank body 21, and a source-connecting tube 204 extending upwardly from the top cover 22.

The partitioner 3 is mounted in the shell 2, and cooperates with the shell 2 to define a first cyclone chamber 61 therebetween. The first cyclone chamber 61 is in fluid communication with the air inlet channel 2051 and the bottom dust-discharging tube 213 so that when an air flow is introduced through the air inlet channel 2051 into the first cyclone chamber 61, the air flow is caused to flow in a helical or vortex pattern within the first cyclone chamber 61, thereby resulting in separation of air from dust carried by the air flow. The partitioner 3 has an upper cup part 30, a cylindrical lower part 32 disposed below and extending downwardly from the upper cup part 30, a connector 35, and a dust-discharging check valve 36. The upper cup part 30 defines a top opening 305 and a cup inner space 314, and is formed with a plurality of cup-wall through-holes 315 in fluid communication with the first cyclone chamber 61 and the cup inner space 314. The cylindrical lower part 32 defines a dust collecting space 316 isolated from the first cyclone chamber 61 and the cup inner space 314, and has a bottom open end 322. The dust-discharging check valve 36 is coupled to the bottom open end 322 of the lower part 32 through the connector 35, and is disposed above and adjacent to the bottom dust-discharging tube 213. The dust collecting space 316 in the lower part 32 is in fluid communication with the first cyclone chamber 61 through the dust-discharging check valve 36. The dust-discharging check valve 36 prevents fluid flow from passing therethrough in a direction from the first cyclone chamber 61 toward the dust collecting space 316. The upper cup part 30 has a bottom wall 301 and a peripheral wall 302 extending upwardly from the bottom wall 301 and formed with a top flange 303 that is supported on the top shoulder 2123. The bottom wall 301 has an outer portion 3011 that is connected transversely to the peripheral wall 302, and an inner portion 3012 that extends from the outer portion 3011 into the cup inner space 314, that tapers upwardly, and that is formed with a plurality of holes 3013. The peripheral wall 302 of the upper cup part 30 has a cylindrical portion 3021 extending upwardly from the bottom wall 301, and a frustoconical portion 3022 extending upwardly and enlarging in diameter from the cylindrical portion 3021.

The multi-cone unit 4 is supported on the upper cup part 30 to cover the top opening 305 of the upper cup part 30, and includes a plurality of cones 40, a connecting flange 41, and an upper cover 42. The cones 40 are equiangularly disposed and are sidewisely interconnected to one another so as to define a central space 43 thereamong. The connecting flange 41 extends radially and outwardly from an upper end portion 45 of the cones 40, is formed with a plurality of engaging holes 414, and is seated on the top flange 303 of the peripheral wall 302 of the upper cup part 30. The connecting flange 41 and the cones 40 are formed into a single piece using moldable plastic. Each of the cones 40 extends downwardly from the connecting flange 41 through the cup inner space 314 and a respective one of the holes 3013 in the inner portion 3012 of the bottom wall 301 of the upper cup part 30 and into the dust collecting space 316. The central space 43 confined by the cones 40 is in fluid communication with the cup inner space 314.

The upper end portion 45 of each of the cones 40 is formed with a tangent channel-forming notch 46 having two opposite sides 461, 462, and has a circumferentially-extending segment 45a and a tangentially-extending segment 45b extending tangentially from the circumferentially-extending segment 45a. The circumferentially-extending segment 45a has an end section 451 that defines an end face 4511. The end face 4511 of the end section 451 of each circumferentially-extending segment 45a is disposed at one of the sides 461 of a corresponding tangent channel-forming notch 46. The tangentially-extending segment 45b of each cone 40 has an inner face 452 that faces toward the end face 4511 of the end section 451 of the circumferentially-extending segment 45a of a corresponding cone 40 and that confines the other of the sides 462 of the corresponding tangent channel-forming notch 46. The tangentially-extending segment 45b of each of the cones 40 sidewisely joins the end section 451 of the circumferentially-extending segment 45a of an adjacent one of the cones 40. Each of the cones 40 defines an upper opening 401, a lower opening 402 in fluid communication with the dust collecting space 316, and a second cyclone chamber 403 in fluid communication with the upper and lower openings 401, 402 and the tangent channel-forming notch 46. The tangent channel-forming notch 46 in each of the cones 40 extends in a tangential direction relative to the corresponding cone 40 so that when an air flow is introduced through each tangent channel-forming notch 46 into the corresponding second cyclone chamber 403, the air flow is caused to flow in a helical or vortex pattern within each second cyclone chamber 403, thereby resulting in separation of air from dust carried by the air flow.

In this embodiment, the tangent channel-forming notch 46 in each of the cones 40 joins the central space 43 confined by the cones 40. The tangentially-extending segment 45b of the upper end portion 45 of each of the cones 40 further has an end face 453 that sidewisely joins and cooperates with the end face 4511 of the end section 451 of the circumferentially-extending segment 45a of an adjacent one of the cones 40 to confine the one of the sides 461 of the tangent channel-forming notch 46 in the upper end portion 45 of the adjacent one of the cones 40.

The multi-cone unit 4 further includes an upper cover 42 disposed on the cones 40 to cover the upper openings 401 of the cones 40. A sealing pad 49 is disposed between and is in sealing contact with the upper end portions 45 of the cones 40 and the upper cover 42. The upper cover 42 is formed with a plurality of engaging studs 422 fitted respectively into the engaging holes 414 of the connecting flange 41, and a plurality of air holes 421 in fluid communication with the source-connecting tube 204 and in fluid communication with the second cyclone chambers 403 in the cones 40, respectively.

The inlet tube 205 is adapted to be connected to a pipeline (not shown). The source-connecting tube 204 is adapted to be connected to an air pressure source (not shown), such as a fan blower, which can be operated in a suctioning mode or a blowing mode. In operation, when the fan blower is operated in the suctioning mode, an air flow carrying dust is drawn into the first cyclone chamber 61 through the pipeline to undergo a first separation of dust from air, then flows through the central space 43 and the tangent channel-forming notches 46 into the second cyclone chambers 403 of the cones 40 to undergo a second separation of dust from air, and finally flows through the air holes 421 of the upper cover 42 and the source-connecting tube 204 into the atmosphere.

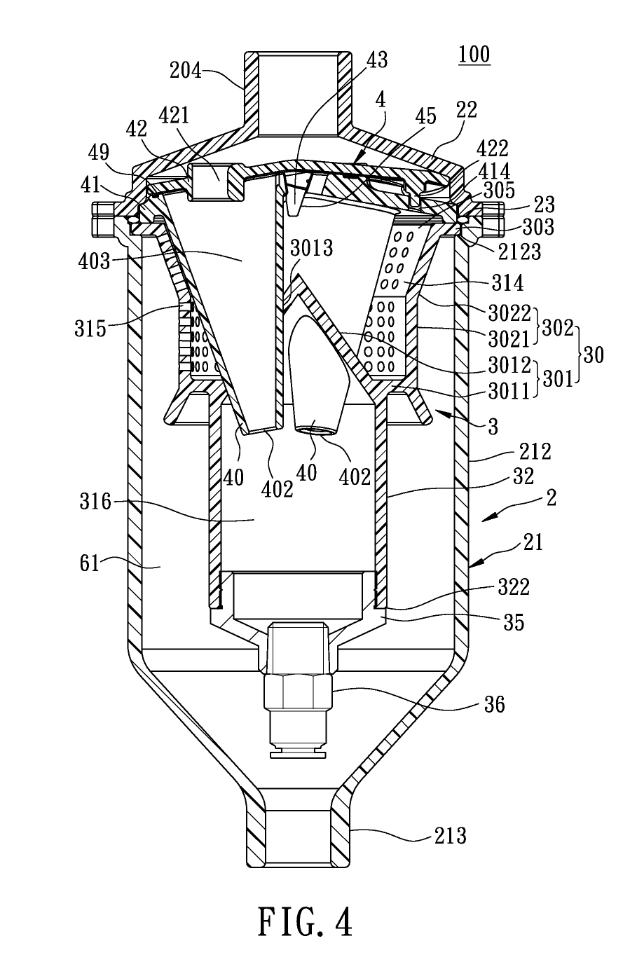

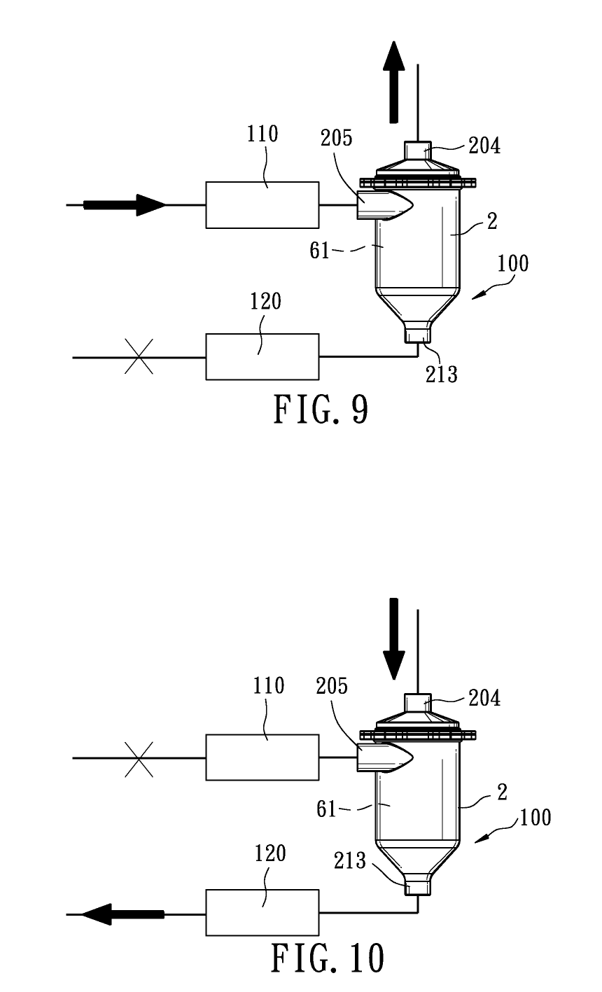

FIGS. 9 and 10 illustrate the second preferred embodiment of the dust separator 100 according to the present invention. The second preferred embodiment differs from the previous embodiment in that the dust separator 100 of the second preferred embodiment further includes an inlet check valve 110 and an outlet check valve 120. The inlet check valve 110 is coupled to the inlet tube 205 so that fluid flow is prevented from passing therethrough in a direction from the first cyclone chamber 61 toward the outside of the shell 2. The outlet check valve 120 is coupled to the bottom dust-discharging tube 213 so that fluid flow is prevented from passing therethrough in a direction from the outside of the shell 2 toward the first cyclone chamber 61. As such, when the fan blower (not shown) connected to the source-connecting tube 204 is operated in a suctioning mode, a dust-containing air flow can only be introduced from the outside of the dust separator 100 through the inlet check valve 110 into the dust separator 100 and then flows through the source-connecting tube 204 into the atmosphere (see FIG. 9), thereby separating dust from air in the air flow, and when the fan blower is operated in a blowing mode, a cleaning air flow can only be introduced from the outside of the dust separator 100 through the source-connecting tube 204 into the dust separator 100 and then flows through the dust-discharging tube 213 and the outlet check valve 120 into the atmosphere (see FIG. 10), thereby removing the dust collected in the dust collecting space 316 (see FIG. 4).

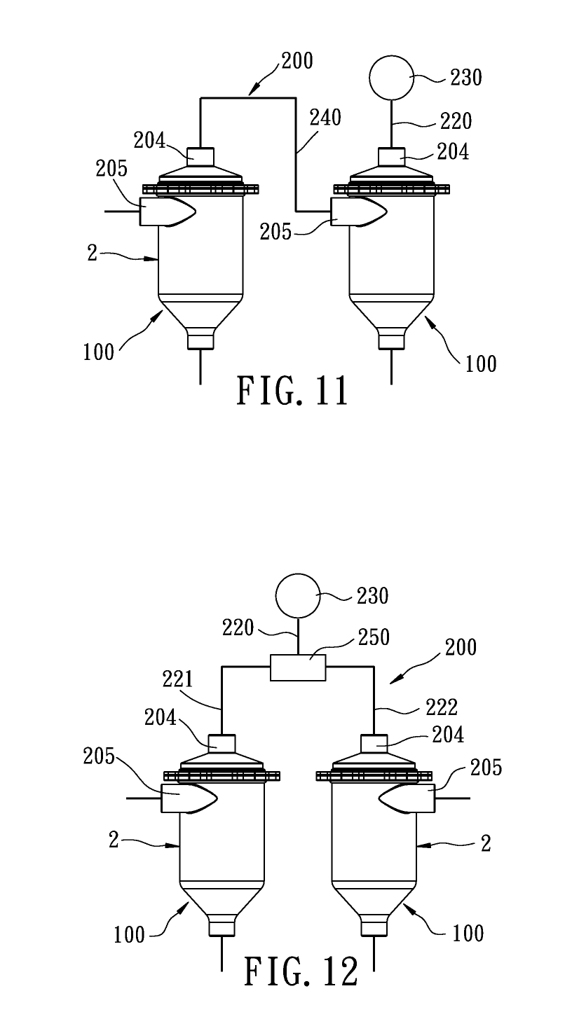

FIG. 11 illustrates the first preferred embodiment of a dust separating system according to the present invention. The dust separating system includes a pair of the above mentioned dust separators 100, a pipeline 200 connected to the dust separators 100, and an air pressure source 230 connected to the pipeline 200 for suctioning air from or blowing air into the dust separators 100 through the pipeline 200.

In this embodiment, the pipeline 200 includes a first connecting conduit 240 interconnecting the source-connecting tube 204 of the shell 2 of one of the dust separators 100 and the inlet tube 205 of the shell 2 of the other one of the dust separators 100, and a second connecting conduit 220 interconnecting the air pressure source 230 and the source-connecting tube 204 of the shell 2 of the other one of the dust separators 100.

FIG. 12 illustrates the second preferred embodiment of the dust separating system according to the present invention. The dust separating system includes a pair of the above mentioned dust separators 100, a pipeline 200 connected to the dust separators 100, a flow control unit 250 connected to the pipeline 200, and an air pressure source 230 connected to the pipeline 200 for suctioning air from or blowing air into the dust separators 100 through the pipeline 200. The flow control unit 250 may include control valves (not shown) and flow sensors (not shown) that are connected to the pipeline 200 in a conventional manner for controlling and directing fluid flow in the pipeline 200.

In this embodiment, the pipeline 200 includes a first connecting conduit 221 interconnecting the source-connecting tube 204 of the shell 2 of one of the dust separators 100 and the flow control unit 250, a second connecting conduit 222 interconnecting the source-connecting tube 204 of the shell 2 of the other one of the dust separators 100 and the flow control unit 250, and a third connecting conduit 220 interconnecting the flow control unit 250 and the air pressure source 230. The flow control unit 250 is operative to control and direct fluid flow between the air pressure source 230 and each of the dust separators 100.

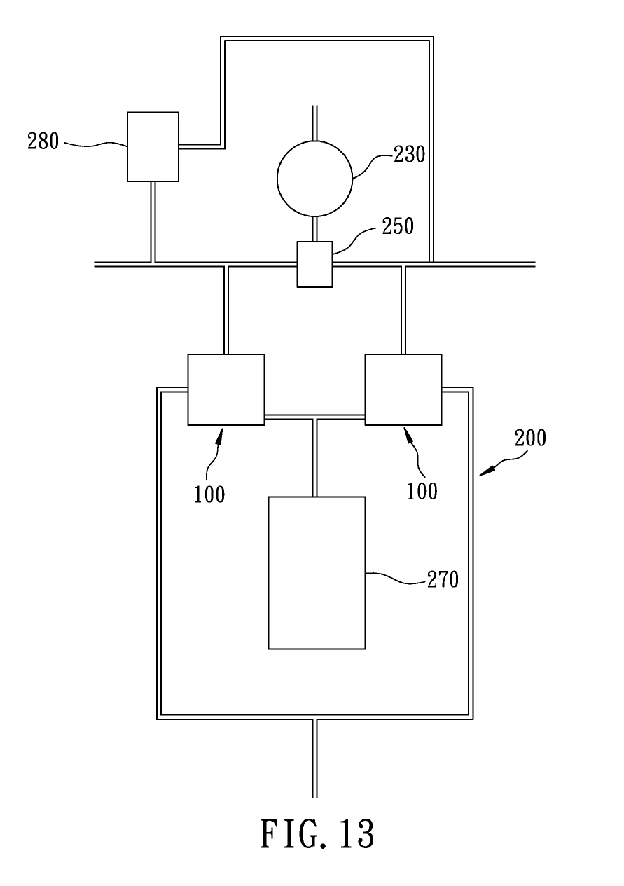

FIG. 13 illustrates the third preferred embodiment of the dust separating system according to the present invention. The dust separating system includes dust separators 100, a pipeline 200 connected to the dust separators 100, a flow control unit 250 connected to the pipeline 200, a cleaning liquid delivery unit 280 connected to the pipeline 200 and adapted to deliver a cleaning liquid into a selected one of the dust separators 100 for cleaning the selected one of the dust separators 100, a waste-collecting unit 270 connected to the pipeline 200 for collecting waste from the selected one of the dust separators 100 during the cleaning operation, and an air pressure source 230 connected to the pipeline 200 for suctioning air from or blowing air into the dust separators 100 through the pipeline 200. In this embodiment, the air pressure source 230 is a fan blower. The cleaning liquid delivery unit 280 may include a water storage tank (not shown) for storing the cleaning liquid, and a water pump (not shown) connected to the water storage tank and the pipeline 200 in a conventional manner so as to deliver the cleaning liquid to the selected one of the dust separators 100 for cleaning purposes.

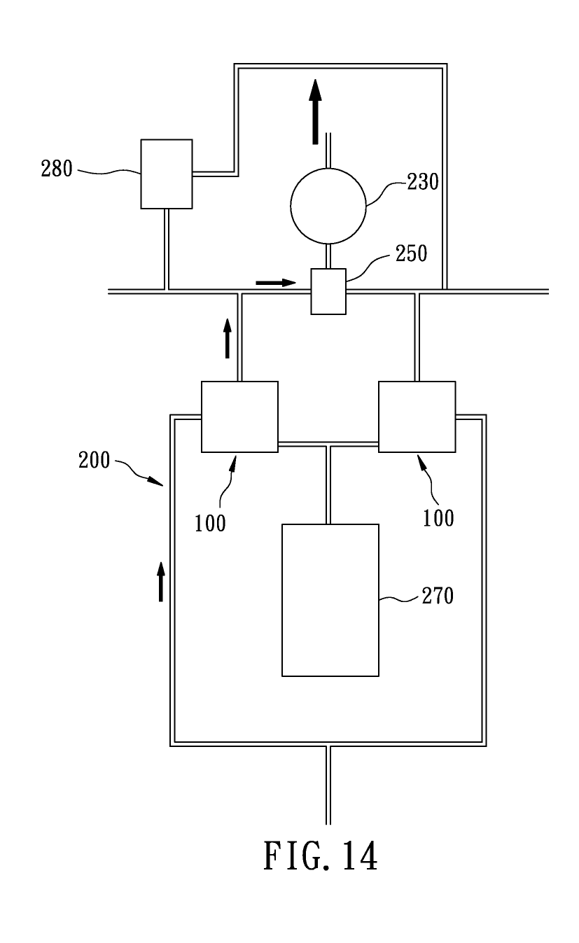

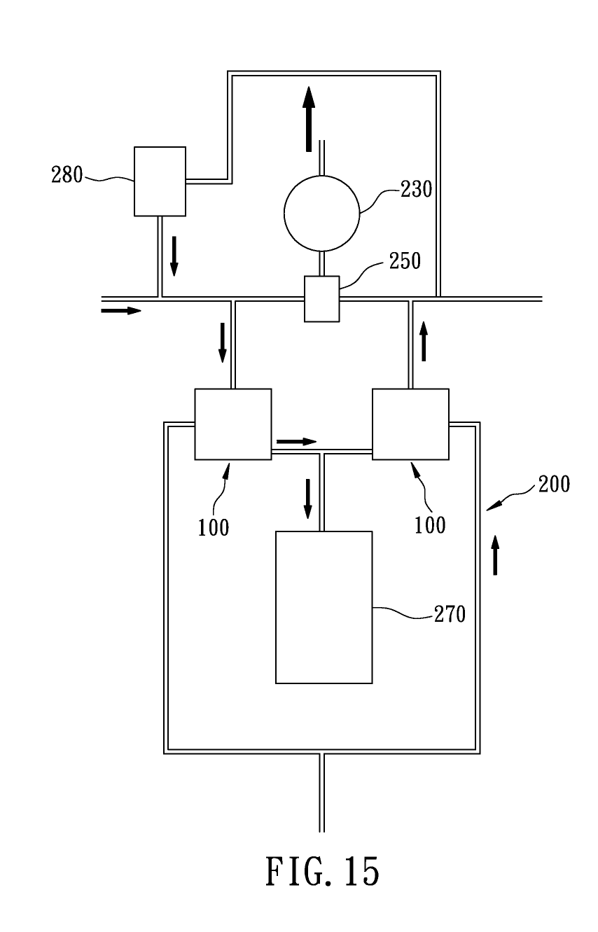

FIG. 14 illustrates an operating state of the dust separating system of the third preferred embodiment, in which one of the dust separators 100 is under a working condition for dust collecting, while the other of the dust separators 100 is maintained in an idle condition. As illustrated in FIG. 15, when the one of the dust separators 100 is almost full of collected dust, the flow control unit 250 can be operated to change the current operating state by switching the other one of the dust separators 100 from the idle condition to the working condition and switching the one of the dust separators 100 from the working condition to a cleaning condition, where the cleaning liquid delivery unit 280 delivers the cleaning liquid into the one of the dust separators 100 for cleaning the one of the dust separators 100. The cleaning operation generates a liquid waste that is directed to the waste-collecting unit 270.

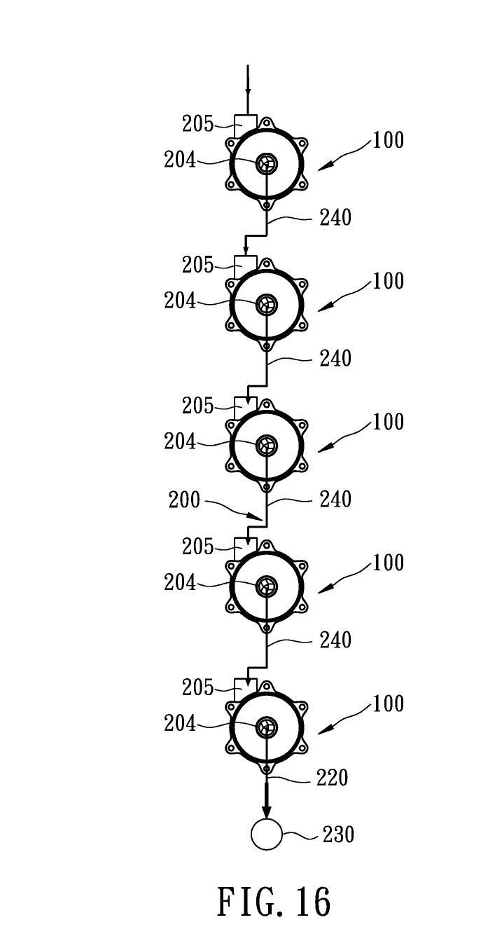

FIG. 16 illustrates the fourth preferred embodiment of the dust separating system according to the present invention. The dust separating system includes a pipeline 200, an air pressure source 230, and five of the dust separators 100 that are connected in series with one another through the pipeline 200. In this embodiment, the pipeline 200 includes a first connecting conduit 240 interconnecting the source-connecting tube 204 of one of the dust separators 100 (except for the endmost one of the dust separators 100) and the inlet tube 205 of a downstream one of the dust separators 100, and a second connecting conduit 220 interconnecting the air pressure source 230 and the source-connecting tube 204 of the endmost one of the dust separators 100.

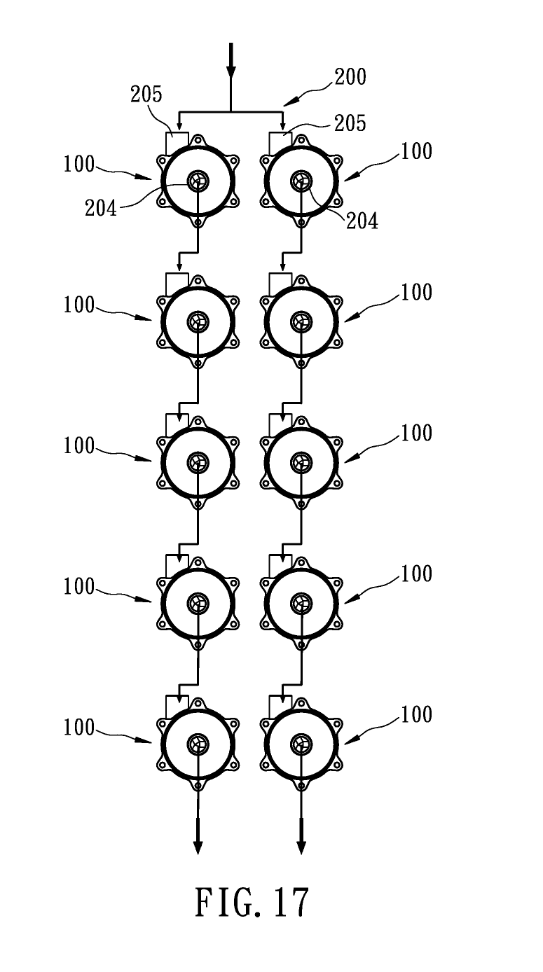

FIG. 17 illustrates the fifth preferred embodiment of the dust separating system according to the present invention. The fifth preferred embodiment differs from the fourth preferred embodiment in that the dust separating system includes ten of the dust separators 100 which are equally divided into first and second groups. The dust separators 100 of the first group are connected in series with one another through the pipeline 200, while the dust separators 100 of the second group are also connected in series with one another through the pipeline 200. The first and second groups of the dust separators 100 maybe connected to each other in a parallel manner.

With the inclusion of the multi-cone unit 4 in the dust separator 100 of this invention, the aforesaid drawbacks associated with the prior art can be alleviated.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A dust separator comprising:
a shell having a cylindrical tank body and an air inlet channel, said air inlet channel extending in a tangential direction relative to said tank body;
a partitioner mounted in said shell and cooperating with said shell to define a first cyclone chamber therebetween, said first cyclone chamber being in fluid communication with said air inlet channel, said partitioner having an upper cup part and a lower part that is disposed below said upper cup part, said upper cup part defining a top opening and a cup inner space and being formed with at least one cup-wall through-hole that is in fluid communication with said first cyclone chamber and said cup inner space, said lower part defining a dust collecting space that is isolated from said first cyclone chamber and said cup inner space; and
a multi-cone unit supported on said upper cup part to cover said top opening of said upper cup part and including a plurality of cones that extend through said cup inner space into said dust collecting space, each of said cones having an upper end portion that is formed with a tangent channel-forming notch having two opposite sides, said upper end portion having a circumferentially-extending segment and a tangentially from said circumferentially-extending segment, said circumferentially-extending segment having an end section that defines an end face, said end face of said end section being disposed at one of said sides of said tangent channel-forming notch, said tangentially-extending segment having an inner face that confines the other of said sides of said tangent channel-forming notch, said tangentially-extending segment of each of said cones sidewisely joining said end section of said circumferentially-extending segment of an adjacent one of said cones, each of said cones defining a lower opening in fluid communication with said dust collecting space, and a second cyclone chamber in fluid communication with said lower opening and said tangent channel-forming notch;
wherein an air flow introduced into said first cyclone chamber via said air inlet channel is caused to flow in a helical pattern to thereby result in a first separation of air from dust carried by the air flow; and
wherein the air flow introduced from said first cyclone chamber into said second cyclone chamber via said tangent channel-forming notches of said cones is caused to flow in a helical pattern to result in a second separation of air from dust carried by the air flow.

2. The dust separator of claim 1, wherein said upper end portions of said cones are sidewisely interconnected to one another so as to define a central space thereamong, said tangent channel-forming notches in said upper end portions of said cones join said central space.

3. The dust separator of claim 1, wherein said tangentially-extending segment of each of said cones further has an end face that sidewisely joins and that cooperates with said end face of said end section of said circumferentially-extending segment of an adjacent one of said cones to confine said one of said sides of said tangent channel-forming notch in said upper end portion of said adjacent one of said cones.

4. The dust separator of claim 1, wherein said multi-cone unit further includes a connecting flange extending radially and outwardly from said upper end portions of said cones, said connecting flange and said cones being formed into a single piece.

5. The dust separator of claim 1, wherein each of said cones further defines an upper opening, said multi-cone unit further including an upper cover that is disposed on said cones to cover said upper openings of said cones, said upper cover being formed with a plurality of air holes that are in fluid communication with said second cyclone chambers in said cones, respectively.

6. The dust separator of claim 1, wherein said upper cup part has a bottom wall and a peripheral wall extending upwardly from said bottom wall, said bottom wall having an outer portion that is connected transversely to said peripheral wall, and an inner portion that extends from said outer portion into said cup inner space and that tapers upwardly, said cones extending through said inner portion of said bottom wall.

7. The dust separator of claim 6, wherein said peripheral wall of said upper cup part has a cylindrical portion extending upwardly from said bottom wall, and a frustoconical portion extending upwardly and enlarged in diameter from said cylindrical portion.

8. The dust separator of claim 6, wherein said tank body has a surrounding wall and a bottom dust-discharging tube extending from said surrounding wall and in fluid communication with said first cyclone chamber, said lower part of said partitioner having a bottom open end, said partitioner further having a dust-discharging check valve that is coupled to said bottom open end of said lower part and that is disposed above and adjacent to said bottom dust-discharging tube, said dust collecting space in said lower part being in fluid communication with said first cyclone chamber through said dust-discharging check valve.

9. The dust separator of claim 8, further comprising an inlet check valve and an outlet check valve, said shell further having an inlet tube extending tangentially from said surrounding wall and defining said air inlet channel, said inlet check valve being coupled to said inlet tube so that fluid flow is prevented from passing therethrough in a direction from said first cyclone chamber to the outside of said shell, said outlet check valve being coupled to said bottom dust-discharging tube so that fluid flow is prevented from passing therethrough in a direction from the outside of said shell to said first cyclone chamber.
